(19) United States
(12) Patent Application Publication
(10) Pub. No.: US 2008/0071845 A1
(43) Pub. Date: Mar. 20, 2008

(54) SYSTEM ENVIRONMENT RECOVERY METHOD

(75) Inventors: Yuzuru Ueda, Kawasaki (JP); Kaoru Ueno, Kawasaki (JP); Masao Yajima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/672,727

(22) Filed: Feb. 8, 2007

(30) Foreign Application Priority Data
Sep. 19, 2006 (JP) 2006-253591

(51) Int. Cl. G06F 17/30

(52) U.S. Cl. 707/204

(57) ABSTRACT

In order to provide a system environment recovery method that enables easy system environment recovery of a plurality of information processor apparatuses without a special environment, the plurality of information processor apparatuses comprise an image file obtaining unit 101 for obtaining an image file 107, an image file writing unit 102 for writing the image file 107 to a storage device 109, an apparatus-specific-information obtaining unit 103 for obtaining apparatus-specific information of the apparatus to which it is connected, an individual-setting-information obtaining unit 104 for obtaining individual-setting information from an individual-setting information list 108 and an individual-setting-information setting unit 105 for applying the individual-setting information to the recovered system environment.

### FIELD OF THE INVENTION

The present invention relates to a system environment recovery method for recovering a system environment established on an information processor apparatus.

### DESCRIPTION OF THE RELATED ART

With improvements in computer performance in recent years, information processor apparatuses have been employed and have been necessary in various fields. In order to carry out business operations smoothly, systems comprising networks such as LAN and WAN with a plurality of information processor apparatuses are used frequently. Construction of a system environment and recovery of the system environment after a failure or other problem are problems that are caused when the scale of a system exceeds a certain level.

FIG. 1 is a diagram showing a configuration example of a system for performing recovery processing of a system environment by employing a deployment server (hereinafter simply referred to as “recovery processing”).

The system shown in FIG. 1 is a system comprising a plurality of information processor apparatuses 701a, 701b, 701c, . . . , 701n, and a deployment server 702 for performing recovery processing of the information processor apparatuses being connected so as to be able to perform communications via a network 703.

The deployment server 702 is a server for providing services such as establishment and recovery processing of the system environment. Individual-setting information such as the IP (Internet Protocol) address in each of the information processor apparatuses 701a-701n is administered and stored by a database 704.

Each of the information processor apparatuses 701a-701n establishes its own environment on the basis of an image file sent from the deployment server 702. Afterwards, each of the information processor apparatuses applies the individual-setting information to itself according to instructions from the deployment server 702.

FIG. 2 is a flowchart showing the recovery processing using a deployment server.

When detecting a certain operation performed by a user, the deployment server 702 starts recovery processing.

In step S801a, the deployment server 702 issues a start-up instruction to an information processor apparatus that is to be a subject of recovery processing (hereinafter referred to as “recovery subject apparatus”).

On the other hand, the recovery subject apparatus that received the start-up instruction from the deployment server 702 turns on its power in step S801c. The process is shifted to step S802c, and the recovery subject apparatus notifies the deployment server 702 of its apparatus-specific information (e.g. MAC (Media Access Control) address).

In step S802a, the deployment server 702 obtains a notification of the apparatus-specific information sent from the recovery subject apparatus.

When obtaining the apparatus-specific information, the deployment server 702 shifts the process to step S803a, reads out an image file in which a system environment was filed in advance from a storage medium or a storage device, and sends the file to the recovery subject apparatus.

In step S803c, meanwhile, the recovery subject apparatus obtains the image file sent from the deployment server 702. The apparatus shifts the process to step S804c, writes the image file obtained in step S803c to a storage device in the recovery subject apparatus, and recovers the system environment.

In addition, when the writing of the image file to the storage device is completed, the recovery subject apparatus shifts the process to step S805c. The apparatus, then, notifies the deployment server 702 of the completion of the writing.

When receiving the writing completion notification from the recovery subject apparatus, the deployment server 702 requests individual-setting information of the recovery subject apparatus to the database 704 that administers the individual-setting information, and shifts the process to step S804a.

Here, the individual-setting information is setting information that is required in order to cause each information processor apparatus to perform desired operations. It can be, for example, information such as a host name, an IP address, and a subnet mask.

On the other hand, the database 704 shifts the process to step S801b when receiving the request of the individual-setting information from the database 704. Afterwards, the database 704 notifies the deployment server 702 of the requested individual-setting information of the recovery subject apparatus.

In step S804a, the deployment server 702 obtains the individual-setting information from the database 704. The deployment server shifts the process to step S805a and notifies the recovery subject apparatus of the individual-setting information obtained in step S804a.

In step S806c, the recovery subject apparatus, when obtaining its individual-setting information from the deployment server 702, shifts the process to step S807c. The apparatus stores the individual-setting information obtained in step S806c in a prescribed file in the storage device comprised in the recovery subject apparatus.

After completing the above processes, the recovery subject apparatus shifts the process to step S808c. The apparatus reads out and activates the OS (Operating System) in the system environment recovered in step S804c from the storage device, and shifts the process to step S809c.

In step S809c, the recovery subject apparatus reads out the individual-setting information stored in step S807c. The apparatus applies the individual-setting information to the system environment using an API (Application Program Interface) or other such interface. For example, the individual-setting information such as host name and IP address is set to the recovery subject apparatus via an API. The apparatus shifts the process to step S810c and ends the processing.

However, when using the deployment server 702, the cost for facility investment and other costs increases since a stable network environment with sufficient bandwidth is required. For that reason, there are difficulties in many cases of introducing the deployment server 702 in systems with a relatively small scale.

Since the recovery processing by the deployment server 702 is performed under a network environment, there are cases of being exposed to a risk of virus infection or an attack on vulnerabilities in the system.

There is a method for recovery processing that does not use deployment servers; in this method, recovery processing is performed by setting a storage medium (a recovery CD 902 in FIG. 3) for storing programs for executing image files and recovery processing to information processor apparatuses 901a, 901b, 901c, . . . , 901n, as shown in FIG. 3.

However, in recovery processing using the recovery CD 902, an administrator has to set the individual settings for each of the information processor apparatuses one by one. Such individual setting, in general, is a complicated process even for small-scale systems, and the tremendous effort and cost required becomes a problem.

Japanese Patent Application Publication No. 2004-038351 discloses a failure recovery method comprising first and second areas, each storing the same programs and data, for facilitating recovery from failures of a computer system and by loading the contents of the area that sets a definition file and by booting the system.

Japanese Patent Application Publication No. 11-073377 discloses an information processor for realizing an undo function in an OS environment independently from the OS by using a special program that resides in Read-Only-Memory, even when an OS environment setting file fails.

### SUMMARY OF THE INVENTION

The present invention is made in view of the above problems, and it is an object of the present invention to provide a system environment recovery method that enables easy system environment recovery of a plurality of information processor apparatuses without a special environment.

In order to achieve this object, the system environment recovery method relating to the present invention obtains, from a storage medium storing the image file, an image file having the contents of a storage device storing a system environment of an information processor apparatus that has been filed in advance, recovers the system environment by writing the image file to the storage device, obtains apparatus-specific information that is unique information enabling the identification of an apparatus from other information processor apparatuses, obtains individual-setting information (setting information required for causing the information processor apparatus to perform a desired operation) of an information processor apparatus specified by the apparatus-specific information from the storage medium storing an individual-setting information list containing the individual-setting information for each information processor apparatus, and enables the desired operation by applying the individual-setting information to the recovered system environment.

Here, the image file is data of the contents of the system environment that has been filed in advance, is data that is to be stored (or that has been stored already) in a storage unit (e.g. a magnetic storage device etc.) comprised in the information processor apparatus, and, for example, it may be data that has been filed exactly and is in a state in which the OS or applications etc. for realizing the system environment is installed in, for example, a magnetic storage device. Therefore, by providing the image file to the storage device comprised in the other information processor apparatus, it is possible to establish the same system environment in the other information processing apparatus.

According to the present invention, an information processor apparatus that is to be a subject of system environment recovery recovers the system environment by reading an image file from a storage medium and by writing the file to a storage device comprised in the information processor apparatus. Afterwards, setting information of the information processor apparatus specified by apparatus-specific information is obtained from an individual-setting information list, and desired operations are enabled by applying the individual-setting information to the recovered system environment. As a result, it is possible to easily recover a system environment without a special environment.

As explained above, according to the present invention, it is possible to provide a system environment recovery method that enables easy system environment recovery of a plurality of information processor apparatuses without a special environment.

### BRIEF DESCRIPTION OF THE DRAWINGS

FIG. 1 is a diagram showing a conventional example of recovery processing employing a deployment server;

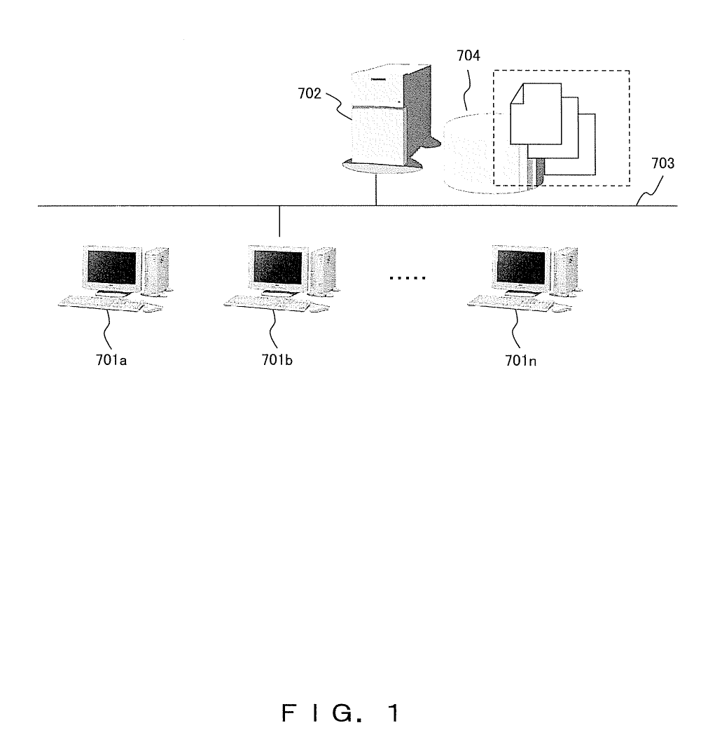

FIG. 2 is a diagram explaining a conventional example of the recovery processing using a recovery CD;

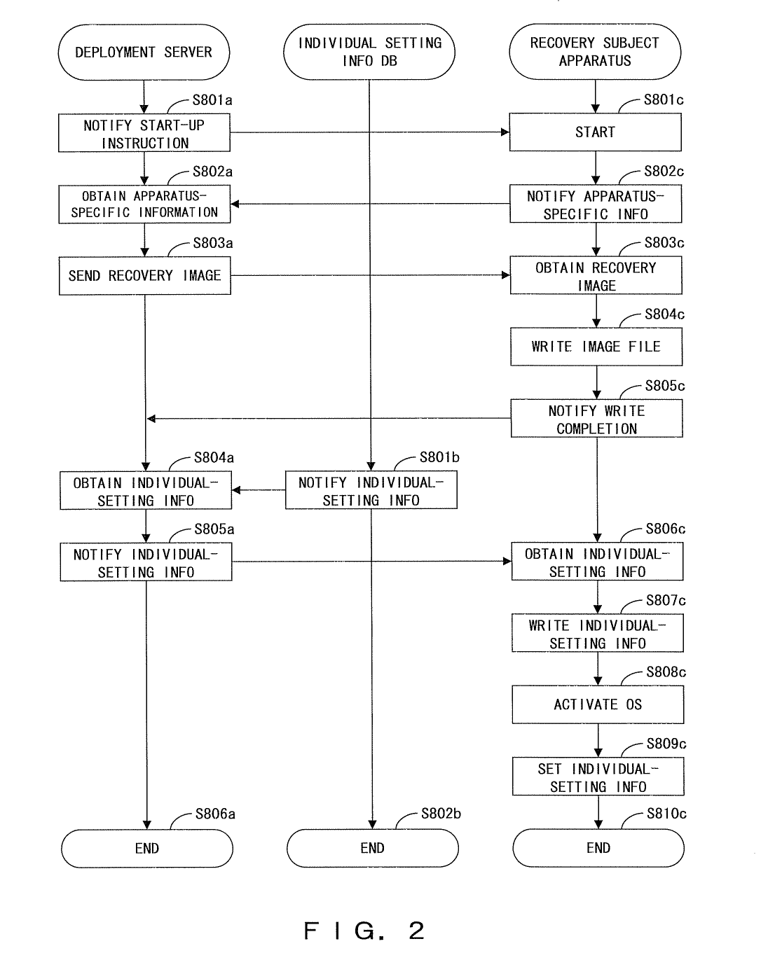

FIG. 3 is a diagram explaining a conventional example of recovery processing that does not use a deployment server;

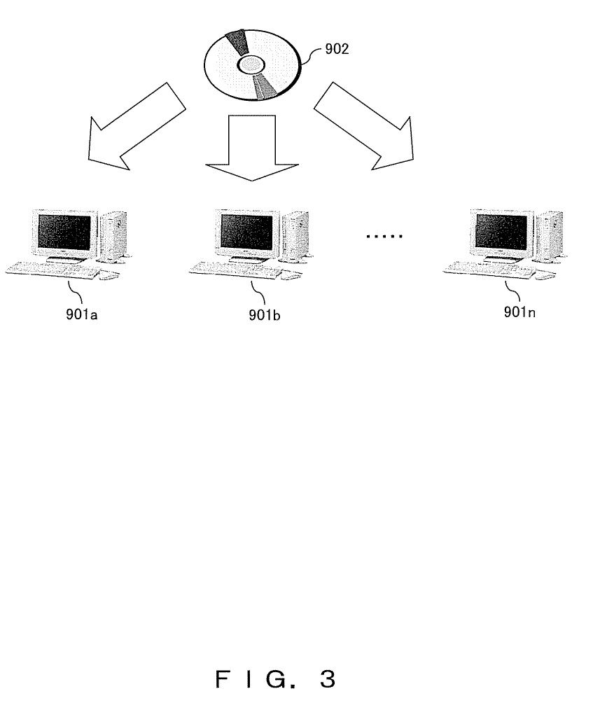

FIG. 4 is a diagram explaining a principle of the system environment recovery method relating to the embodiment of the present invention;

FIG. 5 is a diagram showing an example of a configuration of the information processor apparatus relating to the embodiments of the present invention;

FIG. 6 is a diagram showing a configuration example of the individual-setting information list relating to the embodiment of the present invention;

FIG. 7 is a diagram showing a modification of the individual-setting information list relating to the embodiment of the present invention;

FIG. 8 is a flowchart showing the recovery processing relating to the embodiment of the present invention; and

FIG. 9 is a flowchart showing the processing for generating the recovery storage medium relating to the embodiment of the present invention.

### DESCRIPTION OF THE PREFERRED EMBODIMENTS

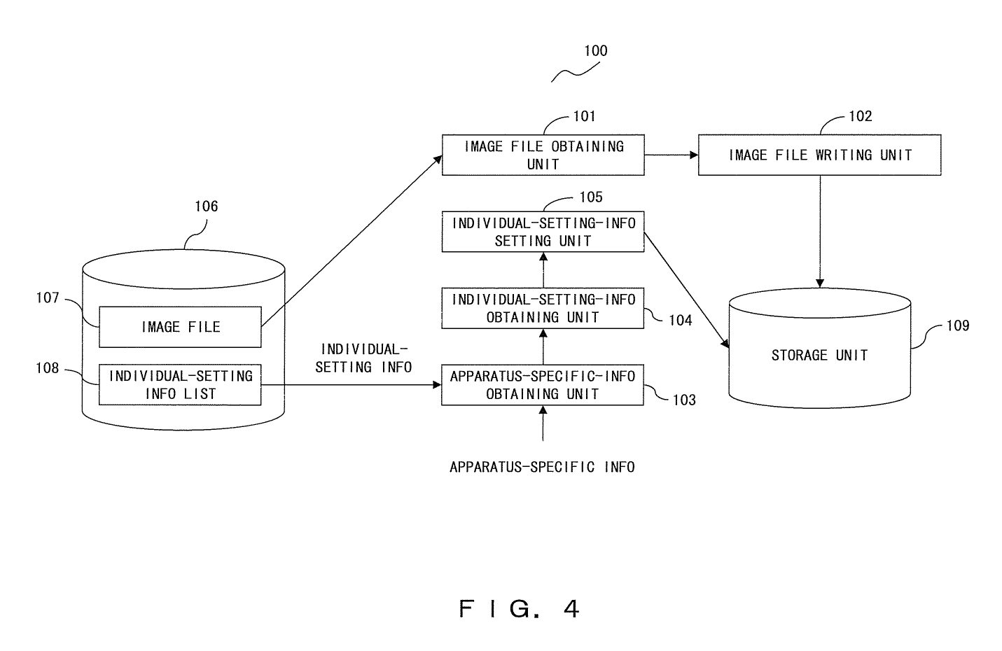

In the following description, preferred embodiments of the present invention are set forth on the basis of FIG. 4-FIG. 9.

FIG. 4 is a diagram explaining a principle of the system environment recovery method relating to the embodiment of the present invention.

An information processor apparatus 100 shown in FIG. 4 is an information processor apparatus for realizing the system environment recovery method relating to the embodiment of the present invention, and comprises an image file obtaining unit 101 for obtaining an image file 107 from a storage medium 106, an image file writing unit 102 for recovering a system environment by writing the image file 107 to a storage device 109, an apparatus-specific-information obtaining unit 103 for obtaining apparatus-specific information of the apparatus, an individual-setting-information obtaining unit 104 for obtaining individual-setting information from an individual-setting information list 108, and an individual-setting-information setting unit 105 for applying the individual-setting information to the recovered system.

The storage medium 106 is a portable storage medium such as CD, DVD, or flash memory. In the storage medium 106, the image file 107 of the system environment, the individual-setting information list 108, and programs (not shown in the drawing) for realizing the system recovery method relating to the present embodiment are stored.

It should be noted that the information processor apparatus 100 relating to the present embodiment reads out the programs immediately after turning on the power, and stores the program-on memory. And, by executing the program instructions, the system recovery method relating to the present embodiment is realized.

The image file 107 is data of the contents of the system environment to be stored (or having been stored already) in advance in a storage unit 109 comprised in the information processor apparatus as explained above, and it can be, for example, data that is filed exactly, a state in which the OS or applications etc. for realizing the system environment are installed on a magnetic storage device or other storage device.

The individual-setting information list 108 stores individual-setting information for all apparatus-specific information. Here, the apparatus-specific information is unique information that enables identification from other information processor apparatuses, and a MAC address, for example, may be used.

The individual-setting information is setting information required to cause each information processor apparatus to perform desired operations. For example, it is information such as the host name, the IP address, and the subnet mask assigned to the information processor apparatus 100.

The storage unit 109 stores information required for establishing a system environment. For example, it can be a storage device in which an OS or a prescribed application etc. is installed. The information processor apparatus 100 establishes the system environment by reading out and executing an OS or a prescribed application from the storage unit 109. Accordingly, when a problem is caused in the OS etc., by overwriting the image file 107, the OS etc. is also overwritten and the system environment is recovered.

When the power is turned on in the information processor apparatus 100, the image file obtaining unit 101 obtains the image file 107 stored in a prescribed address in the storage medium 106. The image file writing unit 102 writes the obtained image file to the storage unit 109. As a result, for example, the OS and business-oriented applications etc., that establish the system environment are recovered to the initial state (or a state of the image file creation).

The apparatus-specific-information obtaining unit 103, on the other hand, obtains, for example, a MAC address that is a unique ID assigned to an Ethernet card in the apparatus as the apparatus-specific information.

The individual-setting-information obtaining unit 104 obtains apparatus-specific information and individual-setting information relating to the corresponding apparatus-specific information from the individual-setting information list 108. The individual-setting-information setting unit 105 applies the individual-setting information obtained by the individual-setting-information obtaining unit 104 to the recovered system environment. For example, the unit sets the IP address, the host name, etc., by using an API of the recovered OS (system environment).

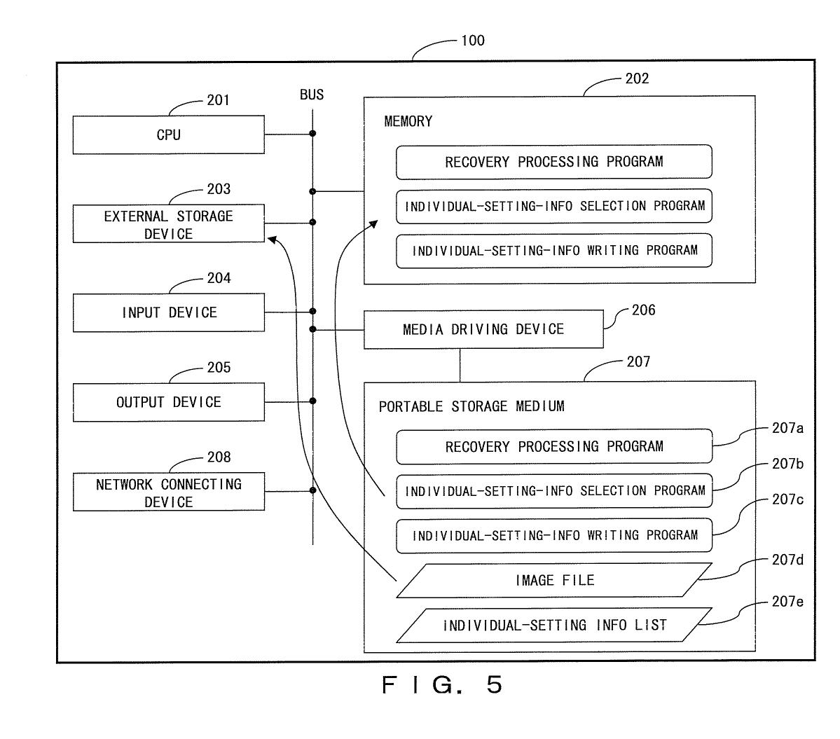

FIG. 5 is a diagram showing an example of a configuration of the information processor apparatus relating to the embodiments of the present invention.

The information processor apparatus 100 shown in FIG. 5 comprises a CPU 201 for executing programs for realizing the recovery processing relating to the present embodiment and for executing peripheral devices and various types of software; volatile memory 202 (e.g. RAM) used for executing the programs; an external storage device 203 for recording the OS, programs and other data etc., required for the operation of the information processor apparatus 100; an input device 204 (e.g., a keyboard or a mouse) that is a data input unit from outside; an output device 205 for displaying data or other things needing to be displayed; a media driver device 206 for reading out programs, data, or other things needing to be read out from a portable storage medium 207 (such as a floppy disk, an MO disk, CD-R, or DVD-R), writing the programs, data, or other things to be written in the memory 202 or the external recoding device 203, or for outputting the data of the memory 202 or the external storage device 203 to the portable storage medium 207; and a network connecting device 208 for connecting to a network. A configuration is established in which these devices are connected by a bus and are able to exchange data with each other.

The recovery processing relating to the present embodiment, explained as follows, includes processing after system environment recovery for applying the individual-setting information to the system.

The portable storage medium 207 shown in FIG. 5 (hereinafter referred to as “recovery storage medium 207”) comprises a recovery processing program 207a for executing the recovery processing, an individual-setting information selection program 207b for selecting the individual-setting information in accordance with its own apparatus from the individual-setting information list 207e, an individual-setting information writing program 207c for setting the individual-setting information, an image file 207d for system environment recovery, and an individual-setting information list 207e that is the individual-setting information of all information processor apparatuses that are subjects of the recovery processing.

When starting the recovery processing, the information processor apparatus 100 reads out the recovery processing program 207a, the individual-setting information selection program 207b, and the individual-setting information writing program 207c from the recovery storage medium 207 via the media driver device 206, and stores them to the memory 202.

The CPU 201 executes the programs in the memory 202 in the order prescribed and the recovery processing is performed.

For example, when the recovery processing program 207a is executed, the CPU 201 reads out an image file from the recovery storage medium 207 via the media driving device 206, stores it to the external storage device 203, and recovers the system environment.

When the individual-setting information selection program 207b is executed, the CPU 201 obtains individual-setting information (e.g., IP address and host name etc.) corresponding to the apparatus-specific information (e.g., MAC address etc.) of its own apparatus from the individual-setting information list 207e.

In addition, when the individual-setting information writing program 207c is executed, the CPU 201 sets the individual-setting information by using, for example, an API that is an interface of the OS.

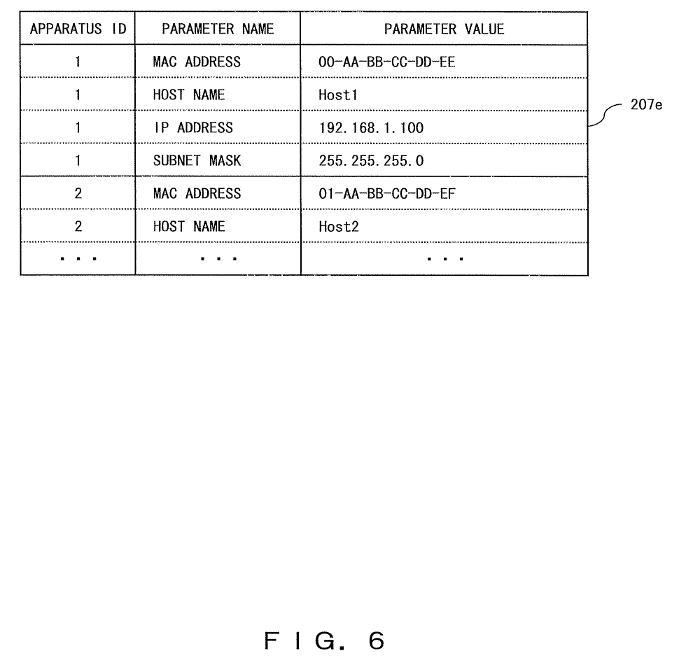

FIG. 6 is a diagram showing a configuration example of the individual-setting information list 207e relating to the embodiment of the present invention.

The individual-setting information list 207e shown in FIG. 6 stores individual-setting information in each information processor apparatus to be the recovery processing subject, and each individual-setting information comprises an apparatus ID, a parameter name, and a parameter value.

The apparatus ID is an identifier for identifying each of the information processor apparatuses. The parameter value is data required for establishing the system environment of each information processor apparatus. FIG. 6 shows a case in which a MAC address, a host name, an IP address and a subnet mask are set to each of the apparatus IDs (information processor apparatuses).

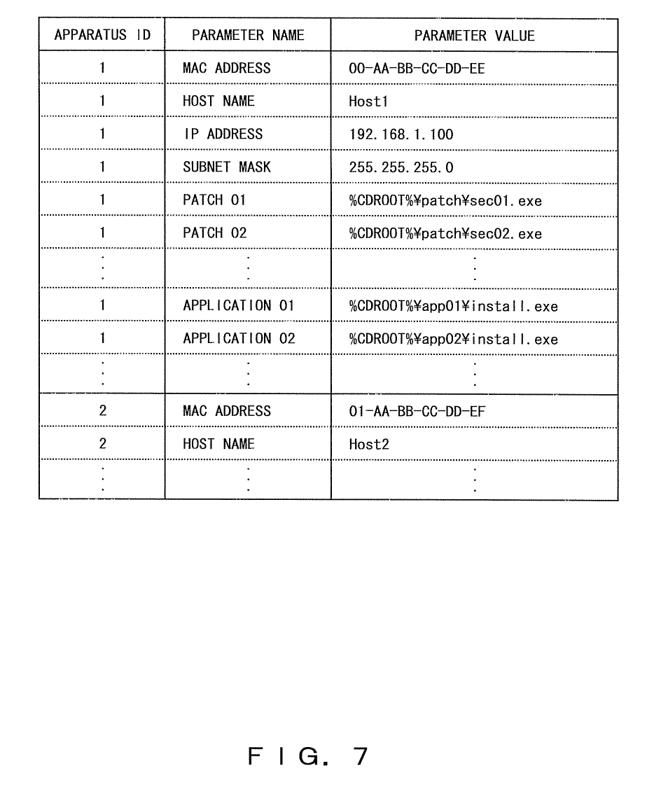

It should be noted that in the individual-setting information list 207e shown in FIG. 6, an example of a minimum data set required for establishment of the system environment is given; however, the data set is not limited to the example, and may have different parameter values as necessary. FIG. 7 shows another example.

FIG. 7 is a diagram showing a modification of the individual-setting information list 207e relating to the embodiment of the present invention.

The parameter values in the individual-setting information list 400 shown in FIG. 7 have program correction patches, patch 01, patch 02, . . . , and business-oriented applications, application 01, application 02, . . . set to each of the apparatus IDs (information processing apparatuses) in addition to a MAC address, a host name, an IP address, and a subnet mask.

Here, patch 01, patch 02, . . . are programs for correcting failures of security or other problems that are present in the OS and applications to be used. Application 01, application 02, . . . are applications used for business in each information processor apparatus.

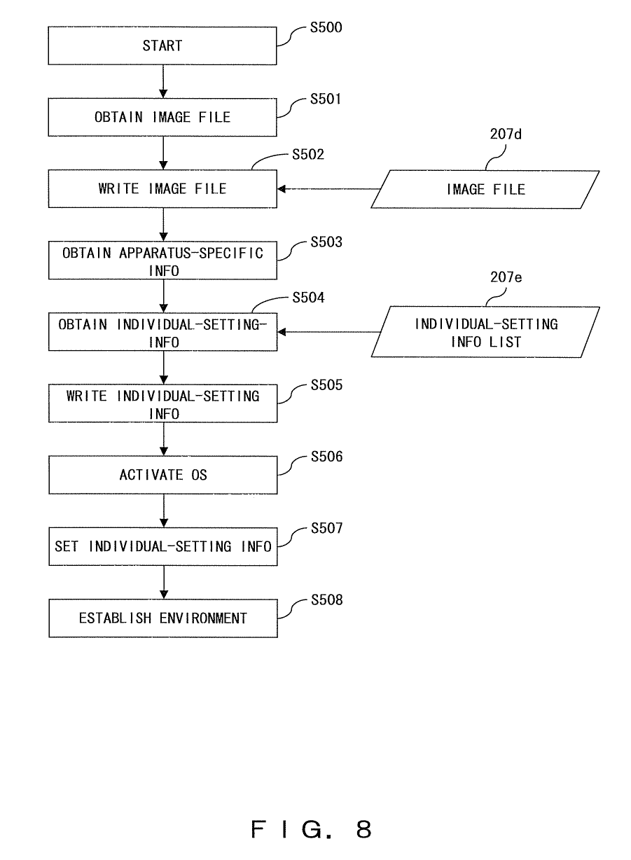

FIG. 8 is a flowchart showing the recovery processing relating to the embodiment of the present invention.

In step S500, when a user sets the recovery storage medium 207 to the recovery subject apparatus and starts, the recovery subject apparatus refers to the recovery storage medium 207. The apparatus, afterwards, stores the recovery processing program 207a to the memory 202 and executes the recovery processing.

In step S501, the recovery subject apparatus refers to the recovery storage medium 207. The apparatus, afterwards, reads out the image file 207d stored in a prescribed address. The recovery subject apparatus shifts the process to step S502, and writes the read image file to a prescribed address of the external storage device 203.

When writing of the image file is completed, the recovery subject apparatus shifts the process to step S503.

In step S503, the recovery subject apparatus obtains the apparatus-specific information of its own apparatus. In the present embodiment, the MAC address that is an ID number unique to the Ethernet card of the network connecting device 208 in its own apparatus is obtained as the apparatus-specific information.

When the apparatus-specific information is obtained, the recovery subject apparatus shifts the process to step S504. The recovery subject apparatus refers to the individual-setting information list 207e stored in a prescribed address of the recovery storage medium 207. The apparatus, afterwards, obtains the individual-setting information of the apparatus ID having a parameter value corresponding to the apparatus-specific information of its own apparatus obtained in step S503.

For example, when the individual-setting information list 207e shown in FIG. 6 is used, the apparatus ID having a parameter value corresponding to the MAC address obtained in step S503 is detected. Afterwards, all parameter values correspond to the detected apparatus ID are read out and obtained. The same operations are performed when the individual-setting information list 400 shown in FIG. 7 is used.

When the individual-setting information is obtained, the recovery storage medium 207 shifts the process to step S505. Afterwards, the information is temporarily stored in, for example, a prescribed address (or file) in the external storage device 203 that the OS can access. This is for the purpose of enabling individual settings by using an API or other interface after starting the OS.

When writing of the individual-setting information is completed, the recovery storage medium 207 shifts the process to step S506 and starts the OS after reading out the OS from the external storage device 203. The process moves on to step S507.

In step S507, the recovery storage medium 207 starts an API for individual settings. The API reads out individual-setting information temporarily stored in step S505, and sets the individual-setting information (such as a host name, IP address, and subnet mask) to the OS and applications etc.

It should be noted that when the individual-setting information list 400 shown in FIG. 7 is used, it is possible to establish an environment setting for each recovery subject apparatus.

When the setting of the individual settings is completed, the recovery storage medium 207 shifts the process to step S508. The medium, then, establishes the environment setting. The environment setting refers to the setting of the operation environment etc. of the OS and certain applications and to corrections of failure etc. For example, the API, by reading out the parameter values of patch 01, patch 02, . . . or application 01, application 02, . . . from among the individual-setting information temporarily stored in step S505, and by executing each of the parameter values, correction patching required for each recovery subject apparatus and application install is performed, and environment setting is established.

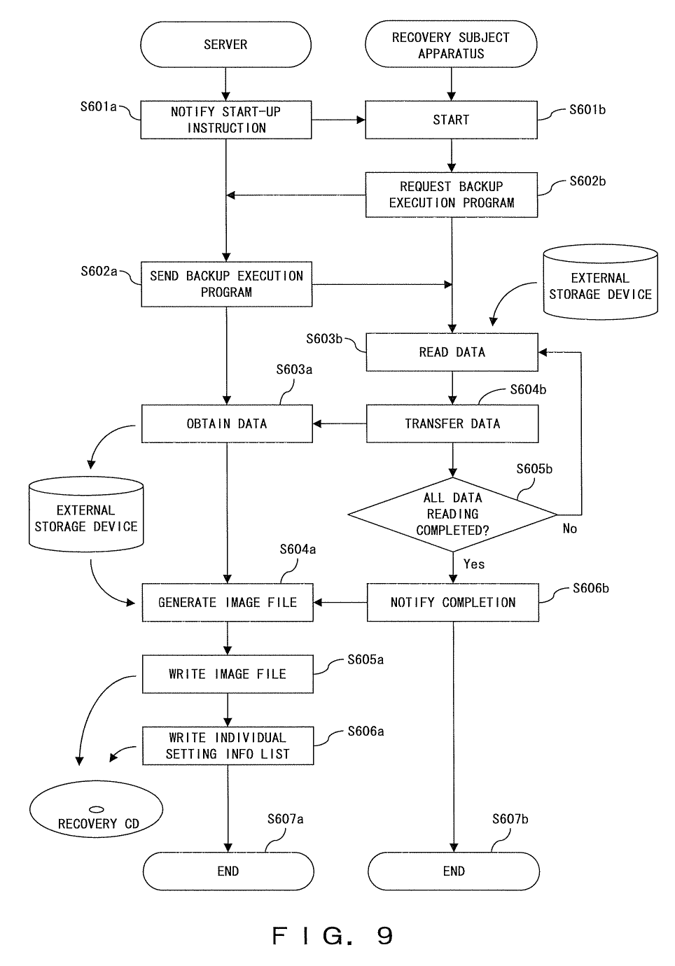

FIG. 9 is a flowchart showing the processing for generating the recovery storage medium 207 relating to the embodiment of the present invention.

Note that in FIG. 9, a case of generating the recovery storage medium 207 (hereinafter referred to as “recovery CD”) using a CD (Compact Disc) as a storage medium is explained.

FIG. 9 shows a case in which a server and a recovery subject apparatus, for example, are connected so as to be able to perform communication with each other by a communication line such as a network, and the server generates a recovery CD; however, the processing is not limited to this example. It is possible to generate a recovery CD with the recovery subject apparatus itself by causing the recovery subject apparatus to execute the processing in the server.

In step S601a, when a prescribed operation by a used is detected, the server starts the recovery CD generation processing and issues a start-up instruction to the recovery subject apparatus.

On the other hand, the recovery subject apparatus that received the start-up instruction from the server turns itself on, and shifts the process to step S602b. Afterwards, the apparatus requires a backup execution program for generating a recovery CD to the server.

When the request for the backup execution program is received from the recovery subject apparatus, the server shifts the process to step S602a. The server, afterwards, reads out the backup execution program from the storage device or other device and sends the program to the recovery subject apparatus.

In contrast, when receiving the backup execution program from the server, the recovery subject apparatus executes the backup execution program and moves the process on to step S603b.

In step S603b, the recovery subject apparatus reads out data of a certain size from the storage device storing the system environment such as the OS and applications. The apparatus, for example, reads out 60 KB of data at a time in sequence starting from the head address. Afterwards, the apparatus moves the process on to step S604b.

In step S604b, the recovery subject apparatus transfers the read data to the server. Afterwards, the apparatus moves the process on to step S605b.

In step S605b, the recovery subject apparatus checks whether or not all data is read out from the storage device. If any data that has not been read out remains, the process is moved on to step S603b, and the processing of steps S603b and S064b is performed on all data. Note that “all data” denotes data stored in the storage device and is data required for establishment of the system environment.

In step S605b, when reading all data is completed, the recovery subject apparatus moves the process on to step S606b. The apparatus notifies the server of the end of the reading processing.

The server, when receiving data from the recovery subject apparatus, shifts the process to step S603a. While data is sent from the recovery subject apparatus, the data is stored in a storage device in the server.

When receiving the end notification of the reading processing from the recovery subject apparatus, the server moves the process on to step S604a and generates an image file by recovering the data stored in step S603a.

When generating the image file, the server moves the process on to step S605a. Afterwards, the generated image file is written to a CD (storage medium). Additionally, the server writes the individual-setting information lists shown in FIG. 6 and FIG. 7 to the CD, and ends the processing.

As explained above, the system environment recovery method relating to the present embodiment is performed by setting a storage medium storing the recovery processing program 207a, the individual-setting information selection program 207b, the individual-setting information writing program 207c, the image file 207d, and the individual-setting information list 207e to each of the recovery subject apparatuses, and by executing the recovery processing program 207a, the individual-setting information selection program 207b, and the individual-setting information writing program 207c at the same time that the power is turned on.

For that reason, an apparatus such as the deployment server 702 for performing recovery processing etc. is not necessary. A special network environment for recovery processing is also not necessary. As a result, it is possible to keep cost low on facility investments etc. Since a network environment is unnecessary, it is possible to easily avoid virus infections and attacks on vulnerabilities in the system.

Consequently, regardless of the scale or size of the system, recovery processing can be performed at a moderate price.

In the system environment recovery method relating to the present embodiment, individual-setting information required for an apparatus is obtained from the individual-setting information list 207e stored in advance in a storage medium, and the individual-setting information is applied to the recovered system environment of its own apparatus by using an API.

Consequently, since an administrator does not have to individually set the settings for each information processor apparatus, it is possible to perform recovery processing easily without great effort or cost.

What is claimed is:

1. A system environment recovery method, comprising:
Obtaining an image file, from a storage medium storing the image file, having the content contained in a storage device storing the system environment of an information processor apparatus, which was filed in advance;
recovering the system environment by writing the image file to the storage device;
obtaining apparatus-specific information that is unique information enabling the identification of an apparatus from among other information processor apparatuses;
obtaining individual-setting information, specified by the apparatus-specific information, of an information processor apparatus from the storage medium storing an individual-setting information list containing, for each information processor apparatus, the individual-setting information required for causing the information processor apparatus to perform a desired operation; and
enabling the desired operation by applying the individual-setting information to the recovered system environment.

2. The system recovery method according to claim 1, wherein
the apparatus-specific information is unique information enabling the identification of an apparatus from among other apparatuses present on a network.

3. The system recovery method according to claim 1, wherein
the individual-setting information includes a correction program for the system environment.

4. The system recovery method according to claim 1, wherein
the individual-setting information includes a prescribed business-oriented application that can be operated in the system environment.

5. A storage medium for storing a program for system environment recovery, causing an information processor apparatus to perform processing of:
reading an image file, from a storage medium storing the image file, having the content of a storage device storing the system environment of an information processor apparatus, which was filed in advance;
recovering the system environment by writing the image file to the storage device;
obtaining apparatus-specific information, from a storage unit storing the apparatus-specific information, that is unique information enabling the identification of an apparatus from among other information processor apparatuses;
reading individual-setting information, specified by the apparatus-specific information, of an information processor apparatus from the storage medium storing an individual-setting information list containing, for each information processor apparatus, the individual-setting information required for causing the information processor apparatus to perform a desired operation; and
enabling the desired operation by applying the individual-setting information to the recovered system environment.

6. The storage medium for storing a program for system environment recovery according to claim 5, wherein
the apparatus-specific information is unique information enabling the identification of an apparatus from other apparatuses present on a network.

7. The storage medium for storing a program for system environment recovery according to claim 5, wherein
the individual-setting information includes a correction program for the system environment.

8. The storage medium for storing a program for system environment recovery according to claim 5, wherein
the individual-setting information includes a prescribed business-oriented application that can be operated in the system environment.

9. An information processor apparatus, comprising:
an image file obtaining unit for obtaining an image file, from a storage medium storing the image file, having the content contained in a storage device storing the system environment of an information processor apparatus, which was filed in advance;
an image file writing unit for recovering the system environment by writing the image file to the storage device;
an apparatus-specific-information obtaining unit for obtaining apparatus-specific information that is unique information enabling the identification of an apparatus from among other information processor apparatuses;
an individual-setting-information obtaining unit for obtaining, from the storage medium storing an individual-setting information list containing the individual-setting information for each information processor apparatus, individual-setting information of an information processor apparatus specified by the apparatus-specific information that is setting information required for causing the information processor apparatus to perform a desired operation; and
an individual-setting-information setting unit for enabling the desired operation by applying the individual-setting information to the recovered system environment.

10. The information processor apparatus according to claim 9, wherein
the apparatus-specific information is unique information enabling the identification of an apparatus from among other apparatuses present on a network.

11. The information processor apparatus according to claim 9, wherein
the individual-setting information includes a correction program for the system environment.

12. The information processor apparatus according to claim 9, wherein
the individual-setting information includes a prescribed business-oriented application that can be operated in the system environment.
